(19) United States
(12) Patent Application Publication
(10) Pub. No.: US 2025/0389920 A1
(43) Pub. Date: Dec. 25, 2025

(54) STORAGE CASE FOR OPTICAL PATCH CORD

(71) Applicant: SANWA TECHNOLOGIES CO., LTD., TOKYO (JP)

(72) Inventor: MASAFUMI IIDA, TOKYO (JP)

(21) Appl. No.: 18/812,220

(22) Filed: Aug. 22, 2024

(30) Foreign Application Priority Data
Jun. 24, 2024 (JP) 2024-101264

(51) Int. Cl. G02B 6/44

(52) U.S. Cl. CPC G02B 6/4457

(57) ABSTRACT

An object of the invention is to provide a storage case for an optical patch cord which can efficiently store a long optical patch cord connecting optical connectors to both ends thereof and wound in a curled manner, is portable, and is excellent in convenience and operability during use. An engaging member and a switch are provided as a rotation control mechanism which rotatably stores a winding reel and a gear fixed to the winding reel in an inner part of a case, the winding reel being energized and retained by a spring in a state in which an optical fiber cord is wound, prevents the winding reel from rotating in a rewinding direction of the optical patch cord by pressure contacting and locking the gear to the lower side within the case, and allows the winding reel to freely rotate by unlocking the gear.

### TECHNICAL FIELD

The present invention relates to a storage case for an optical patch cord, and more particularly to a storage case for an optical patch cord which can adjust a drawing-out length of a cord length step by step and is portable with an automatic winding mechanism.

### BACKGROUND ART

In the past, an optical patch cord in which optical connectors are connected to both ends of an optical fiber cord wound in a curled manner has been known as a device used for an optical connection in a data center and various measuring devices. Further, as a length of the optical fiber cord of this kind patch cord, for example, 1 m, 1.5 m, 2 m etc. exist in association with a connecting length of both the optical connectors.

Thus, the longer the length of the optical fiber cord is, the more the size of a whole device is enlarged and the heavier the weight thereof is. As a result, the device is very inconvenient to carry.

In order to solve the problem mentioned above, various storage devices storing the optical patch cord has conventionally proposed as shown in the following patent literatures.

First of all, in patent literature 1, there is disclosed a device in which an optical fiber tape core wire exposed out of an optical cable is introduced into a box-like housing, a fixing part is provided and fixed to an appropriate position of an inner cylinder integrally disposed within the housing, a drawing-in part for the optical fiber tape core wire is attached to the inner cylinder, the optical fiber tape core wire having a necessary length for a work of operating to an end part of an optical connector in an outer part of the housing from a portion fixed to the fixing part of the optical fiber tape core is wound around the inner cylinder and a drawing-in member with maintaining a space with respect to an outer cylinder integrally formed with the housing at a fixed curvature or more, and an access control part for the optical fiber tape core wire is disposed in the housing, thereby keeping the optical fiber tape core wire at the necessary length for the operating work, and processing an excess length of the optical fiber tape core wire.

Further, in patent literature 2, there is disclosed an optical cable excess length processing tool including a winding part which has a radius of curvature equal to or more than an allowable minimum bend radius of an optical fiber cable, a reel which includes a pair of flanges disposed with sandwiching the winding part therebetween, a reel case which has an opening with such a shape as to fit to the flange, corresponds to a bottomed tubular container storing the reel winding the optical fiber cable thereto from the opening, and forms a notch communicating with the opening, and a fixing member which fixes the reel into the reel case.

Further, in patent literature 3, there is disclosed an optical fiber assembly having a housing, a spool which is rotatably arranged within the housing, an optical waveguide which is wound around the spool. The optical waveguide has an optical fiber with no jacket in a center part, and short optical fibers with jackets terminating at an optical connecter in both ends. The optical waveguide is wound around the spool, and is wound to or drawn out from the spool by rotating in the same direction. A bias is applied to the spool in a first direction for the housing by a torsion spring, and gives a return force to the optical fibers with jackets. A mechanical stopper is provided for preventing the rotation in a second direction which is opposite to the first direction.

### CITATION LIST

### Patent Literature

Patent Literature 1: Japanese Unexamined Patent Application Publication No. H06-109930
Patent Literature 2: Japanese Unexamined Patent Application Publication No. 2008-33013
Patent Literature 3: Japanese Unexamined Patent Application Publication (Translation of PCT Application) No. 2006-519419

### SUMMARY OF INVENTION

### Technical Problem

However, the optical fiber excess length processing device shown in the patent literature 1 mentioned above is configured to wind the optical tape core wire of the optical cable connecting the optical connector in one end thereof around the inner cylinder and the outer cylinder fixed to the inner part of the rectangular housing while maintaining a fixed space each other, and be provided in the rectangular housing with an opening part where the optical fiber tape core wire is accessible and a control part. Therefore, this device is basically different not only in an object and a function of the invention but also in a structure itself from the storage device for the optical patch cord in which the optical connectors are connected to both ends of the optical fiber cord wound in a curled manner, and is significantly inconvenient for carrying due to an enlarged size of its entire structure.

Further, in the optical cable excess length processing tool shown in the patent literature 2 mentioned above, an operator winds the optical fiber cable to a winding part according to a manual operation in a state in which the winding part of the reel is exposed out of an upper opening of the reel case by an energizing force of the spring, and the operator thereafter presses the reel into an inner part of the reel case against the energizing force of the spring and turns a screw, thereby fixing the reel to the inner part of the reel case. Thus, the patent literature 1 is basically different from the storage device for the optical patch cord in the same manner as the patent literature 1 mentioned above, the drawing-out length of the optical cable can not be adjusted step by step when drawing the optical cable wound to the winding part of the reel from the reel case, and the optical cable can not be easily drawn in the reel case according to one-touch operation, thereby lacking in the convenience and the operability.

Further, the optical fiber assembly shown in the patent literature 3 mentioned above is basically deemed to be the storage device for the optical patch cord in which the optical connectors are connected to both ends of the optical fiber cord wound in a curled manner, however, is structured such that the optical patch cord is wholly wound to one spool, and is stored in an inner part of a housing constituted by a housing base and a housing cover in a state of following a plurality of channels (routes) on an upper face of the spool, and a mechanical stopper preventing the rotation of the spool is arranged on an outer face of a tubular wall of the housing base in such a manner as to freely engage with and disengage from curved spool flanges in both ends of the spool, thereby drawing out or storing two optical fiber cords from one gateway disposed lateral to the housing. Therefore, it is complicated to store the optical patch cord in the housing and long time and much labor are required, thereby extremely deteriorating the operability.

Further, the mechanical stopper according to the patent literature 3 has a complex structure, and the rotation of the spool can not be smoothly stopped by the mechanical stopper. Thus, it is hard in precision to draw the optical fiber cord out of the gateway of the housing to adjust to a predetermined length.

Further, since only one gateway is provided lateral to the housing, it is hard to simultaneously and smoothly draw two optical fiber cords according to a manual operation, thereby causing any entanglement.

Accordingly, the present invention is made for solving various problems while taking into consideration the conventionally existing known arts as mentioned above, and aims at providing a storage case for an optical patch cord which can efficiently store a long optical patch cord connecting optical connectors to both ends thereof and wound in a curled manner, is portable, and is excellent in convenience and operability during use.

### Solution to Problem

In order to achieve the object mentioned above, the present invention is provided with a rotation control mechanism which rotatably stores a winding reel and a gear fixed to the winding reel in an inner part of a case, the winding reel being energized and retained by a spring in a state in which an optical fiber cord in an optical patch cord having optical connectors connected to both ends of the optical fiber cord is wound, prevents the winding reel from rotating in a rewinding direction of the optical patch cord by pressure contacting and locking the gear to the lower side within the case, and allows the winding reel to freely rotate by unlocking the gear,

wherein the rotation control mechanism is formed by an engaging member which is retained by an energizing force of a spring in a direction of always pressure contacting and locking a leading end to an outer peripheral face of the gear, and a switch which selectively operates the engaging member to pressure contact and lock to the outer peripheral surface of the gear, or to unlock against the energizing force of the spring the pressure contacting and the locking.

The engaging member is formed by a pawl which is axially supported in a base end thereof rotatably to a protruded shaft disposed in an inner wall of the case, is retained in the leading end thereof by the energizing force of the spring in the direction of always pressure contacting and locking to the gear, and is provided with a guide pin in a protruding manner below the leading end.

The switch is provided with a manual operation body which is fitted and inserted to a lower wall of the case so as to be slidable in a longitudinal direction, and a guide body for the pawl which is disposed above an upper part of the manual operation body while passing through the lower wall of the case, the guide body forms in a back face thereof a guide groove which is upward inclined toward a rear side from a front side, and the guide pin for the pawl is slidably fitted and inserted to the guide groove.

The gear is configured to alternately form a sliding part constructed by an inclined face on which the pawl leading end energized and retained by the spring slides over an outer whole periphery, and a locking part constructed by a vertical wall face to which the pawl leading end is locked.

The guide groove of the guide body is formed by an upper frame which is upward inclined toward a rear side from a front side in a rear end edge of a back plate, and a front frame and a rear frame which are continuously disposed vertically below both ends of the upper frame.

A vertical width in a rear end side of the guide groove is formed to be wide so that the guide groove serves as a clearance part for the lock pin when the pawl pressure contacted to the outer periphery of the gear under rotation swings.

The case is formed by coupling opening ends of a pair of two half cases having an approximately rectangular shape in a side view in a lid-fitting manner, and a gateway for the optical fiber cord wound to the winding reel is formed in a front part side of the switch of the rotation control mechanism.

One of the half cases is provided in an inner side thereof with a support shaft which is inserted and attached in a leading end thereof to a holding hole of the other half case, and the winding reel and the gear stored in the inner part of the case are axially supported rotatably to the support shaft.

A circular recess is disposed in a center part of the gear, a through hole of the support shaft is disposed in a center part of the recess, and a power spring energizing and retaining the winding reel in a state in which the optical fiber cord is wound is loaded to an inner part of the recess.

A split groove inserting to wind and fix an inner end of the power spring is formed in the support shaft which axially supports rotatably the winding reel and the gear.

A projection part having a circular arc shape is disposed along an inner periphery of the circular recess in the center part of the gear, and a guide groove inserting to wind and fix an outer end of the power spring and having a circular arc shape is formed between the recess and the projection part.

The winding reel of the optical fiber cord stored in the inner part of the case is formed as double winding reels, the gateway for the optical fiber cord formed in the case is disposed at a lower position facing each reel of the double winding reels, and two optical fiber cords drawn out of the reels are formed in such a manner as to be put in and out in a side-by-side arranged state from the gateway.

The double winding reels are provided with a center flange between the gears arranged in both side faces and an outer flange, and two recess parts for winding the optical fiber cord are formed in an adjacent state between an outer peripheral edge of the gear and the center flange and between the center flange and the outer flange.

A cord guide is disposed in each of corner edge parts just above the gateways in two optical fiber cords, in a pair of two half cases constructing the case.

Each of the cord guides disposed in a pair of two half cases is formed in both bottom faces in the arc-shaped part in such a manner as to keep an allowable minimum bend radius of the optical fiber cord.

Each of the cord guides disposed in a pair of two half cases is provided with a back part in a protruding manner in a rear side of both the arc-shaped parts, is provided with an upper wall part protruding toward a direction of the arc-shaped part in a protruding manner in a center upper end of the back part, and is formed into an approximately C-shaped form in a front view including an opening part for inserting and removing the optical fiber cord in a front side of the back part.

The engaging member is formed as a leaf spring which has an approximately V-shaped form in a side view and is made of metal or plastic, by an inclined spring plate which is retained by the energizing force of the spring in the direction of always pressure contacting and locking to the gear, a holding frame which is fitted and fixed to the support shaft provided in a protruding manner in the case inner wall in the spring plate base plate part and has an approximately U-shaped form in a side view, and a horizontal spring plate which is provided in an extending manner in a lower part of the horizontal frame.

The switch is provided with a manual operation body which is fitted and inserted to the lower wall of the case in the longitudinal direction, and a press bar which passes through the lower wall of the case in the upper part of the manual operation body and is horizontally disposed in a rear side of the upper part, and is configured to press and move down an inclined spring plate above the switch with the press bar by sliding the manual operation body of the switch to a direction of the leaf spring, and to unlock pressure contacting and locking with respect to the outer peripheral face of the gear.

The optical connector connected to both ends of the optical fiber cord is an optical connector of any type of LC type, FC type, SC type, MU type, ST type, KC type, MPO type and MPX type.

### Effect of Invention

The present invention is provided with the rotation control mechanism which rotatably stores the winding reel and the gear fixed to the winding reel in the inner part of the case, the winding reel being energized and retained by the spring in a state in which the optical fiber cord in the optical patch cord having the optical connectors connected to both ends of the optical fiber cord is wound, prevents the winding reel from rotating in the rewinding direction of the optical patch cord by pressure contacting and locking the gear to the lower side within the case, and allows the winding reel to freely rotate by unlocking the gear, wherein the rotation control mechanism is formed by the engaging member which is retained by the energizing force of the spring in the direction of always pressure contacting and locking the leading end to the outer peripheral face of the gear, and the switch which selectively operates the engaging member to pressure contact and lock to the outer peripheral surface of the gear, or unlock the pressure contact and lock against the energizing force of the spring. Therefore, an entire structure is downsized, and the device can be portable. Further, it is possible to adjust the drawing-out length of the optical fiber cord in the optical patch cord from the gateway of the case step by step, and easily draw the optical fiber cord in the case with a one-touch operation, and the device is extremely excellent in convenience and operability.

The engaging member is formed by the pawl which is axially supported in the base end thereof rotatably to the protruded shaft disposed in the inner wall of the case, is retained in the leading end thereof by the energizing force of the spring in the direction of always pressure contacting and locking to the gear, and is provided with the guide pin in a protruding manner below the leading end. Further, the switch is provided with the manual operation body which is fitted and inserted to the lower wall of the case so as to be slidable in the longitudinal direction, and the guide body for the pawl which is disposed above the upper part of the manual operation body while passing through the lower wall of the case, the guide body forms in the back face thereof the guide groove which is upward inclined toward the rear side from the front side, and the guide pin for the pawl is slidably fitted and inserted to the guide groove. Therefore, when the manual operation body is slid to one side in the longitudinal direction of the case lower wall, the pawl rotates upward around the protruded shaft disposed in the base end of the pawl and pressure contacts and locks to the gear, in association with the movement of the guide pin of the pawl fitted and inserted to the guide groove in the back face of the guide body to the upper part of the guide groove with the energizing force of the spring. On the other hand, when the manual operation body is slid to the other side in the longitudinal direction of the case lower wall, the pawl rotates downward around the protruded shaft disposed in the base end of the pawl and can cancel the pressure contacting and the locking with respect to the gear, in association with the movement of the guide pin of the pawl fitted and inserted to the guide groove in the back face of the guide body to the lower part of the guide groove against the energizing force of the spring.

Further, the gear is configured to alternately form the sliding part constructed by the inclined face on which the pawl leading end energized and retained by the spring slides over the outer whole periphery, and the locking part constructed by the vertical wall face to which the pawl leading end is locked. The guide groove of the guide body is formed by the upper frame which is upward inclined toward the rear side from the front side in the rear end edge of the back plate, and the front frame and the rear frame which are continuously disposed vertically below both ends of the upper frame. The vertical width in the rear end side of the guide groove is formed to be wide so that the guide groove serves as the clearance part for the lock pin when the pawl pressure contacted to the outer periphery of the gear under rotation swings. Therefore, a swing motion of the pawl can be smoothly performed, and there is no risk that any trouble is generated during the operation.

The engaging member is formed as the leaf spring which has the approximately V-shaped form in a side view and is made of metal or plastic, by the inclined spring plate which is retained by the energizing force of the spring in the direction of always pressure contacting and locking to the gear, the holding frame which is fitted and fixed to the support shaft provided in a protruding manner in the case inner wall in the spring plate base plate part and has the approximately U-shaped form in a side view, and the horizontal spring plate which is provided in an extending manner in the lower part of the holding frame. The switch is provided with the manual operation body which is fitted and inserted to the lower wall of the case in the longitudinal direction, and the press bar which passes through the lower wall of the case in the upper part of the manual operation body and is horizontally disposed in the rear side of the upper part, and is configured to press and move down the inclined spring plate above the switch with the press bar by sliding the manual operation body of the switch to the direction of the leaf spring, and to unlock pressure contact and locking with respect to the outer peripheral face of the gear. Therefore, an entire structure can be further downsized, simplified and weight reduced, and it is possible to widely reduce a manufacturing cost as well as being extremely portable.

Further, in the present invention, the winding reel of the optical fiber cord stored in the inner part of the case is formed as the double winding reels, the gateway for the optical fiber cord formed in the case is disposed at the lower position facing each reel of the double winding reels, and two optical fiber cords drawn out of the reels are formed in such a manner as to be put in and out in a side-by-side arranged state from the gateway. Further, the cord guide is disposed in the edge part just above the optical fiber cord gateway of the case, the cord guide forming the arc-shaped part in such a manner as to keep the allowable minimum bend radius of the optical fiber cord in the bottom face thereof. Therefore, it is possible to effectively prevent any accidental trouble such as damage and disconnection of the optical fiber cord caused by contact of the optical fiber cord with the corner part of the case when drawing out any one optical fiber cord among two optical fiber cords to the rear side of the case.

### BRIEF DESCRIPTION OF DRAWINGS

FIGS. 1A to 1F show one aspect of a storage case for an optical patch cord for carrying out the present invention, in which FIG. 1A is a front elevational view, FIG. 1B is a back elevational view, FIG. 1C is a plan view,

FIG. 1D is a bottom elevational view, FIG. 1E is a left side elevational view, and FIG. 1F is a right side elevational view;

FIG. 2 is a perspective view of the storage case for the optical patch cord;

FIG. 3 is a cross sectional view along a line A-A in FIG. 1E;

FIGS. 4A to 4F show one half case constructing the storage case for the optical patch cord, in which FIG. 4A is an internal view, FIG. 4B is a right side elevational view, FIG. 4C is a left side elevational view, FIG. 4D is a bottom elevational view, FIG. 4E is an external view, and FIG. 4F is a cross sectional view along a line B-B in FIG. 4A;

FIGS. 5A to 5E show the other half case constructing the storage case for the optical patch cord, in which FIG. 5A is an internal view, FIG. 5B is a right side elevational view, FIG. 5C is a left side elevational view, FIG. 5D is a bottom elevational view, and FIG. 5E is an external view;

FIGS. 6A to 6D show one aspect of a geared winding reel stored in an inner part of the case, in which FIG. 6A is a front elevational view, FIG. 6B is a back elevational view, FIG. 6C is a side elevational view, and FIG. 6D is a cross sectional view along a line C-C in FIG. 6A;

FIG. 7 is a front elevational view showing a state in which a power spring is loaded to the geared winding reel;

FIGS. 8A to 8E show one aspect of the power spring, in which FIG. 8A is a front elevational view, FIG. 8B is a right side elevational view, FIG. 8C is a left side elevational view, FIG. 8D is a plan view, and FIG. 8E is a back elevational view;

FIGS. 9A to 9E show one embodiment of a pawl locking a gear, in which FIG. 9A is a front elevational view, FIG. 9B is a right side elevational view, FIG. 9C is a left side elevational view, FIG. 9D is a plan view, and FIG. 9E is a bottom elevational view;

FIGS. 10A to 10G show one embodiment of a slide switch locking or unlocking the pawl with respect to the gear, in which FIG. 10A is a front elevational view, FIG. 10B is a back elevational view, FIG. 10C is a right side elevational view, FIG. 10D is a left side elevational view, FIG. 10E is a plan view, FIG. 10F is a bottom elevational view, and FIG. 10G is a perspective view as seen from a lower side of the back face;

FIGS. 11A to 11D show one embodiment of a torsion spring energizing the pawl in a gear direction, in which FIG. 11A is a front elevational view, FIG. 11B is a plan view, FIG. 11C is a bottom elevational view, and FIG. 11D is a back elevational view;

FIG. 12 is a side elevational view of a partial cross section and shows a state in which a guide pin of the pawl is fitted and inserted to a guide groove disposed in a guide body above a slide switch;

FIG. 13 is a partly enlarged cross sectional view showing an installed portion of the pawl and the slide switch in the case for storing the optical patch cord;

FIG. 14 is a partly enlarged cross sectional view showing a state in which the pawl and the slider switch when locking are installed to the installed portion in the case for storing the optical patch cord;

FIG. 15 is a partly enlarge cross sectional view showing a state in which the pawl and the slider switch when unlocking are installed to the installed portion in the case for storing the optical patch cord;

FIGS. 16A to 16E show one example of a used state when two optical patch cords are drawn out of a case gateway in a state in which the optical fiber cord connecting an optical connector to a leading end of the case for storing the optical patch cord is wound to a winding reel within the case, in which FIG. 16A is a front elevational view, FIG. 16B is a back elevational view, FIG. 16C is a side elevational view, FIG. 16D is a plan view, and FIG. 16E is a bottom elevational view;

FIG. 17 is a side elevational view showing the other example of the used state when one of two optical patch cords is drawn toward an opposite direction to the case gateway;

FIG. 18A is a side cross sectional view showing a state in FIG. 16, FIG. 18B is a side cross sectional view showing a state in which the optical patch cord is drawn out a little from the state in FIG. 16, and FIG. 18C is a side cross sectional view showing a state in which the optical patch cord is drawn out to a desired length from the state in FIG. 16;

FIG. 19A is a side cross sectional view when the lock is cancelled in the state in FIG. 18C, and FIG. 19B is a side cross sectional view showing a state in which the optical patch cord drawn out to the length in FIG. 19A by unlocking is wound to the winding reel and drawn near the case gateway;

FIGS. 20A to 20F show one embodiment of a slide switch according to the other example, in which FIG. 20A is a front elevational view, FIG. 20B is a back elevational view, FIG. 20C is a right side elevational view, FIG. 20D is a plan view, FIG. 20E is a bottom elevational view, and FIG. 20F is a perspective view as seen from a lower side of the back face;

FIG. 21 is a partly enlarged front elevational view showing an installed state of a leaf spring and a slide switch in a case for storing an optical patch cord according to the other example;

FIG. 22 is a front elevational view of the same when locking a gear in the case for storing the optical patch cord according to the other example; and

FIG. 23 is a front elevational view of the same when unlocking the gear in the case for storing the optical patch cord according to the other example.

### DESCRIPTION OF EMBODIMENTS

A description will be in detail given below of the best mode for carrying out a storage case for an optical patch cord according to the present invention with reference to the accompanying drawings.

The present invention is constructed by main constituting members including a case 1 which has an approximately rectangular shape in a side view, a winding reel 2 which is stored within the case 1, a gear 3 which is fixed to one side face of the winding reel 2, one long optional fiber cord 4 which is wound to the winding reel 2, two optical connectors 5 which are connected to both ends of the optical fiber cord 4, and a rotation control mechanism 6 for the winding reel 2 and the gear 3.

Two optical connectors 5 connected to both ends of the optical fiber cord 4 may employ any type of optical connector among LC type, FC type, SC type, MU type, ST type, MPO type and MPX type optical connectors, and the kind thereof is not restricted.

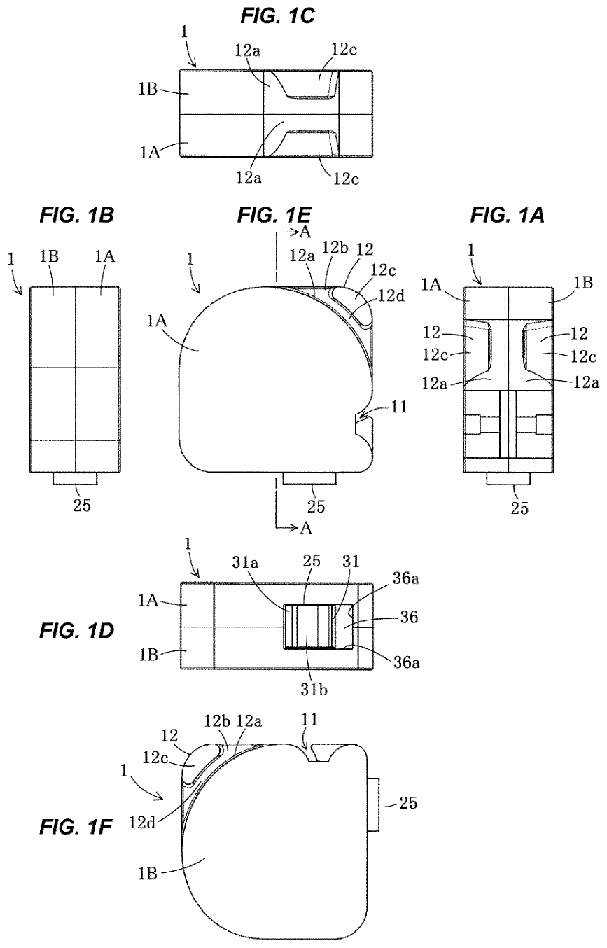

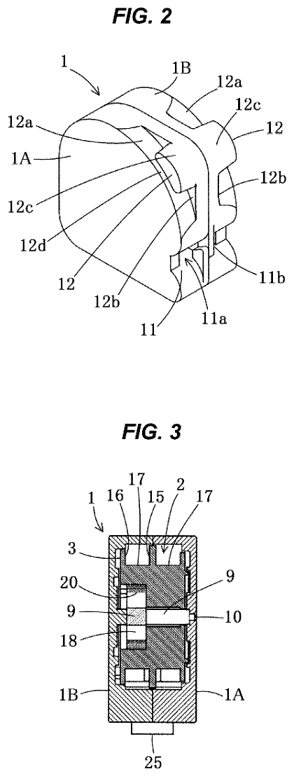

The case 1 is formed, as shown in FIGS. 1 to 5, into a hollow shape in such a manner as to store the winding reel 2, the gear 3 and the rotation control mechanism 6 therefor in an inner part thereof by coupling opening ends of a pair of two half cases 1A and 1B having an approximately rectangular shape in a side view in a lid-fitting manner.

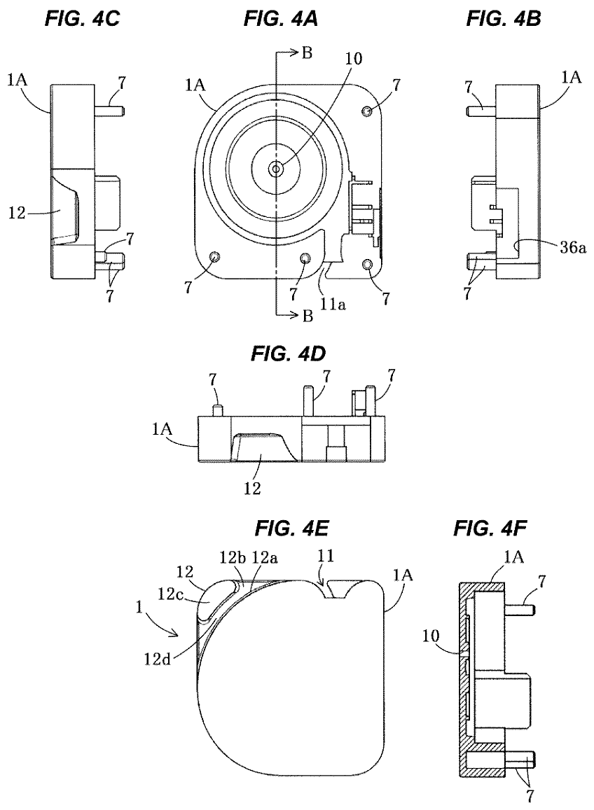

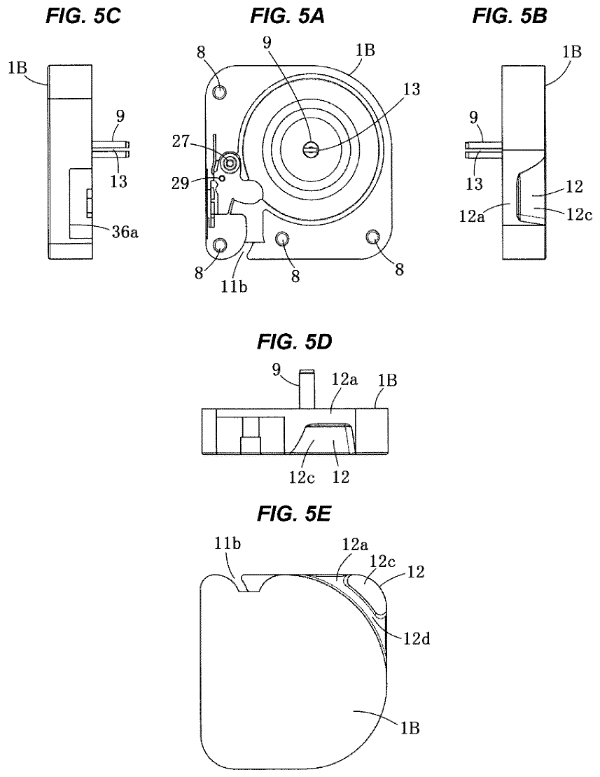

More specifically, as shown in FIGS. 4 and 5, a plurality of (four in the present embodiment) fixing pins 7 are provided in a protruding manner on an outer periphery inside the other half case 1A, and the fixing pins 7 are fitted to the same number of support holes 8 which are pierced at opposing positions of the one half case 1B, so that both the half cases 1A and 1B are firmly connected to be combined into one case 1.

A support shaft 9 axially supporting the winding reel 2 and the gear 3 rotatably is provided in a protruding manner in a center part slightly above the inner side of the half case 1B, and a corresponding position of the half case 1A is provided with a holding hole 10 to which a leading end of the support shaft 9 of the half case 1B is inserted and attached.

According to the structure mentioned above, the support shaft 9 can be stably supported axially within the case 1, can prevent the winding reel 2 and the gear 3 from swinging when rotating, and allows the winding reel 2 and the gear 3 to smoothly rotate.

In FIGS. 1 to 5, reference numeral 11 denotes a gateway of the optical fiber cord 4 formed below a front face of the case 1, reference numeral 12 denotes a cord guide which is disposed in a corner edge part just above the gateway 11 of the case 1, and reference numeral 13 denotes a split groove which is disposed in the support shaft 9, respectively.

Details of the gateway 11, the cord guide 12 and the split groove 13 will be mentioned later.

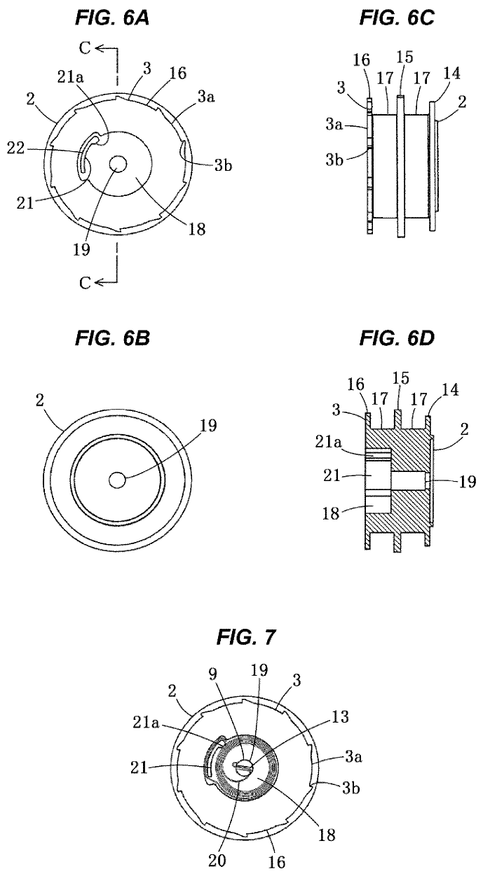

The winding reel 2 is formed as double winding reels which are integral with the gear 3 as shown in FIG. 6.

More specifically, the winding reel 2 according to the present embodiment is formed in a state in which a center flange 15 is disposed between the gears 3 arranged in both side faces and an outer flange 14, and two optical fiber cord 4, and two recess face parts 17 for winding are adjacently disposed between an outer peripheral edge 16 of the gear 3 and the center flange 15 and between the center flange 15 and the outer flange 14.

In the present embodiment, the outer peripheral edge 16 of the gear 3 is commonly used as a flange of the winding reel 2, however, the gear 3 may be independently fixed to one side face of a single winding reel 2 which is provided with two flanges 2 in both sides and one in the center. Further, single winding reel 2 including one optical fiber cord 4 and one recess face part 17 for winding can be used.

In the outer peripheral edge 16 of the gear 3, there are formed over a whole periphery alternately a sliding part 3a constructed by an inclined face on which a pawl leading end energized and retained by a spring (mentioned later) slides, and a locking part 3b constructed by a vertical wall face to which the pawl leading end is locked.

As shown in FIG. 7, a circular recess 18 is disposed in a center part of the gear 3, a center part of the recess 18 is provided with a through hole 19 through which the support shaft 9 of the half case 1B passes together with the winding reel 2, and a power spring 20 is loaded to an inner part of the recess 18, the power spring 20 energizing and retaining the winding reel 2 in a state in which the optical fiber cord 4 is wound.

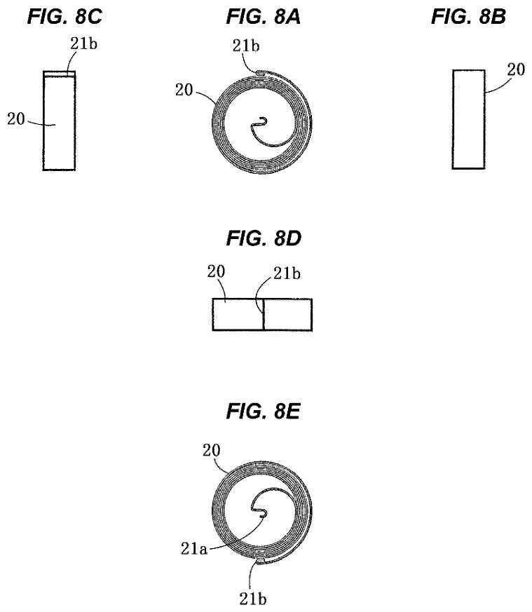

In the power spring 20, as shown in FIG. 8, a winding stop part 21a wound and fixed to an outer periphery of the support shaft 9 after being inserted into the split groove 13 of the support shaft 9 is formed in a spring inner end which is wound like a coil, and a winding stop part 21b wound and fixed to a rear end of a projection part 21 mentioned later of the recess 18 is formed in a spring outer end.

The projection part 21 is formed into an arc shape via a narrow guide groove 22 near an inner periphery of the recess 18, and a locking projection edge part 23 wound and fixed by the winding stop part 21b after an outer periphery of the power spring 20 is inserted into the guide groove 22 is provided in a rear end thereof so as to protrude inward.

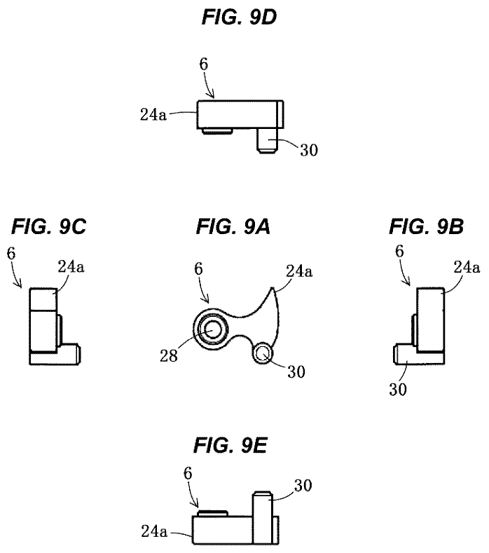

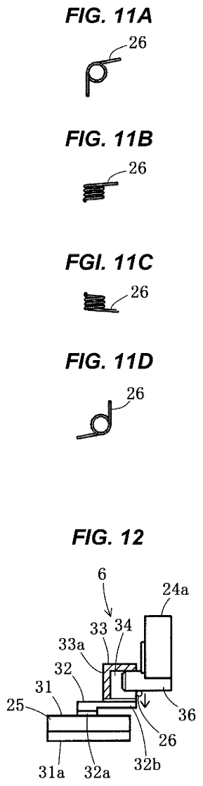

The rotation control mechanism 6 for the winding reel 2 and the gear 3 is constructed by a pawl 24a serving as an engaging member 24 for the gear 3, a slide switch 25 and a torsion spring 26, as shown in FIGS. 9, 10, 11, 12, 14 and 15.

In the pawl 24a, as shown in FIG. 9, a shaft hole 28 axially supported rotatably to a protruded shaft 27 provided in an inner wall of the half case 1B is formed in a base end, a leading end is retained by an engaging force of the torsion spring 26 wound to the other protruded shaft 29 disposed near the protruded shaft 27 of the half case 1B in a locking direction to the gear 3 (a direction of an arrow in FIG. 14), and a guide pin 30 is provided in a protruding manner below the leading end.

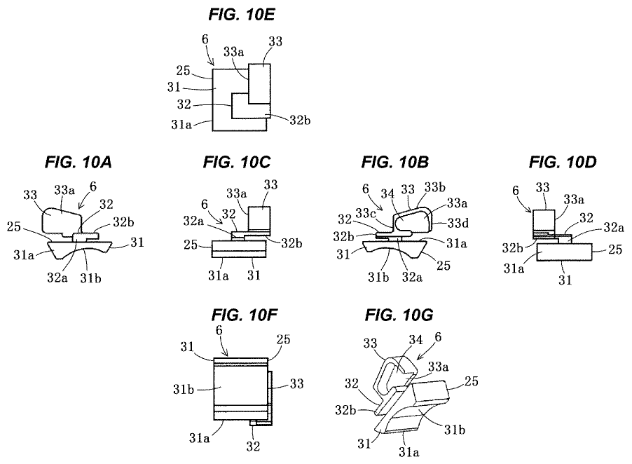

The slide switch 25 is provided with a manual operation body 31, a sliding body 32 which is disposed in an upper face of the manual operation body 31, and a guide body 33 which is disposed in a rear side of an upper face of the sliding body 32, as shown in FIGS. 10, 12, 14 and 15.

The manual operation body 31 is formed by a rectangular plate 31a as shown in FIGS. 1D, 10, 12, 14 and 15, an upper face of the rectangular plate 31a is formed into a flat face, and a recess face part 31b provided with slip stopping knurls (not shown) for hand and finger operation is formed in a lower face.

In the sliding body 32, as shown in FIGS. 10, 12, 14 and 15, a rectangular block 32a is firmly fixed to the center of an upper face of the manual operation body 31, and a rectangular support plate 32b extending to a forward and back face direction of the rectangular plate 31a of the manual operation body 31 is firmly fixed to an upper part of the rectangular block 32a.

In the guide body 33, as shown in FIGS. 10, 12, 14 and 15, a guide groove 34 upward inclined toward a rear side from a front side is formed in a back face, and a guide pin 30 of the pawl 24a is slidably fitted and inserted to the guide groove 34.

More specifically, the guide body 33 is provided with an upper frame 33b which is upward inclined toward a rear side from a front side in a rear end edge of a back plate 33a, and a vertical front frame 33c and a vertical rear frame 33d which are continuously provided in lower sides of both ends of the upper frame 33b. A guide groove 34 having an opening part 33e to which the guide pin 30 of the pawl 24a is slidably fitted and inserted is formed in a rear side of the back plate 33a by the upper frame 33b, the front frame 33c and the rear frame 33d.

Further, in the guide groove 34, a front end height is formed to be substantially equal to a diameter of the guide pin 30, and a rear end height is formed to be larger than the diameter of the guide pin 30. Thus, the guide pin 30 of the pawl 24a is set to be movable up and down in a rear end of the guide groove 34, however, a description on its function will be mentioned later.

Next, a description will be given of an attached state of the rotation control mechanism 6 formed by the pawl 24a (corresponding to the engaging member 24) and the slide switch 25, to the case 1 on the basis of FIGS. 1, 4, 5, and 13 to 15.

A guide bore 36 which is shallow and has a rectangular shape in a plan view is formed in the center of a bottom face of a lower wall 35 close to the gateway 11 of the optical fiber cord 4 in the case 1. An upper face of the manual operation body 31 of the slide switch 25 is fitted to the guide bore 36.

The guide bore 36 is formed in such a manner that a lateral width (depth) is substantially equal to a lateral width of the manual operation body 31 of the slide switch 25, and a vertical width (longitudinal width) is such a length that the pawl 24a slides between a locking position and an unlocking position with respect to the gear 3.

The case 1 is formed by coupling the opening ends of the half case 1A and the half case 1B, as shown in FIGS. 1, 4 and 5. Therefore, the rectangular guide bore 36 formed in the center of the lower wall 35 of the case 1 is also formed by coupling a pair of notch holes 36a and 36a which are respectively formed in bottom wall ends of both the half cases 1A and 1B.

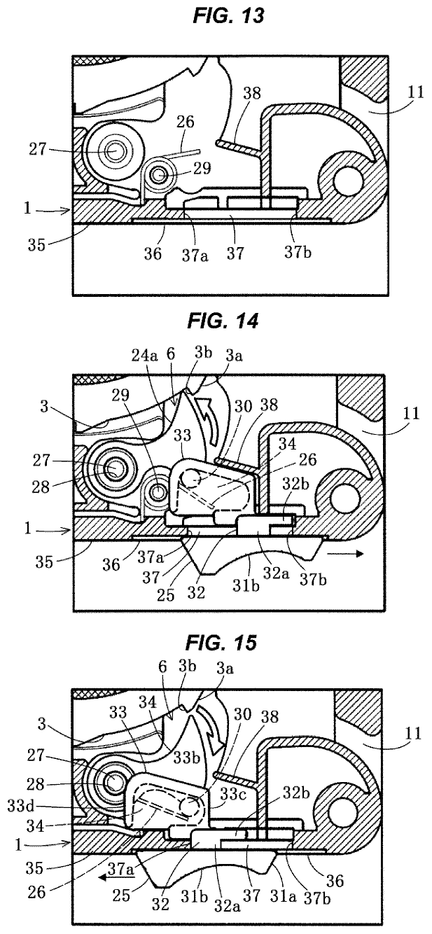

Further, a guide hole 37 is formed in an upper part of the shallow guide bore 36 in the lower wall 35 of the case 1 so as to be communicated with the guide bore 36, as shown in FIGS. 13 to 15. The sliding body 32 firmly fixed to the upper face of the slide switch 25 can move along the guide hole 37 in a longitudinal direction.

The guide hole 37 is formed to have such a length that a rear end of the rectangular block 32a and a leading end of the rectangular support plate 32b c collide in association with the sliding of the manual operation body 31 of the slide switch 25 between the locking position and the unlocking position of the pawl 24a.

In FIG. 13, reference symbol 37a denotes a rear end edge of the guide hole 37 with which the rear face of the rectangular block 32a collides, and reference symbol 37b denotes a front end edge with which the leading end of the rectangular support plate 32b collides. In FIGS. 13 to 15, reference numeral 38 denotes an inclination pressing plate for the upper frame 33b of the guide body 33 which is firmly fixed to the upper part of the rectangular support plate 32b.

The gateway 11 of the optical fiber cord 4 disposed below the front part of the case 1 is formed to be combined into one part in such a manner as to put in and out two optical fiber cords 4 in a side by side arranged state, at opposing positions to the reels (two recess face parts 17) of the double winding reels 2, by coupling gateway half bodies 11a and 11b which are respectively open to the half case 1A and the half case 1B, as shown in FIGS. 1, 2, 4 and 5.

Two cord guides 12 are formed in both sides of the case 1, that is, the corner edge parts just above the half bodies 11a and 11b of the gateways 11 of two optical fiber cords 4 in the half case 1A and the half case 1B constructing the case 1.

More specifically, in a pair of two cord guides 12 provided in the half case 1A and the half case 1B, an arc-shaped part 12a is formed so as to keep an allowable minimum bend radius of the optical fiber cord 4 in both bottom faces, a back part 12b is provided in a rising manner in a rear side of each of both the arc-shaped parts 12a, an upper wall part 12c extending toward the arc-shaped part 12a is provided in a protruding manner in each of upper ends at the center of the back parts 12b, and an opening part 12d for inserting and removing the optical fiber cord 4 is provided in a front side of each of the back parts 12b. Thus, the cord guides 12 are formed into an approximately C-shaped form in a front view.

Next, a description will be given of use and motion of the embodiment structured as mentioned above on the basis of FIGS. 13 to 19.

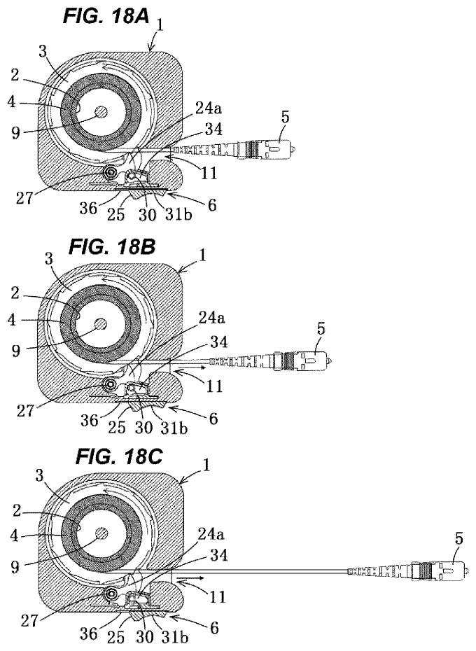

First, as shown in FIG. 18A, when the optical fiber cord 4 of the optical patch cord is wound to the winding reel 2 rotating in a counterclockwise direction shown by an arrow in the drawing by the energizing force of the power spring 20 within the case 1, and the optical connector 5 is positioned at a predetermined position near the cord gateway 11 of the case 1, the rotation of the winding reel 2 stops, and the rotation of the gear 3 integral with the winding reel 2 also simultaneously stops. At this time, the pawl 24a corresponding to the engaging member 24 for the rotation control mechanism 6 of the gear 3 is pressure contacted with the outer periphery of the gear 3. FIG. 18A shows a state in which the pawl 24a pressure contacted with the outer periphery of the gear 3 locks the locking part 3b in the outer periphery of the gear 3.

A description will be in detail given below of a motion of the gear 3 and the rotation control mechanism 6 for operating to an illustrated state in FIG. 18A.

As shown in FIG. 14, a hand or finger is applied to the recess face part 31b of the manual operation body 31 in the slide switch 25 fitted to the guide bore 36 of the lower wall 35 in the case 1, and the manual operation body 31 of the slide switch 25 is moved to a front side of the case 1 (to the cord gateway 11).

When the slide switch 25 is moved as mentioned above, the rectangular block 32a of the sliding body 32 fixed to the upper face of the manual operation body 31 slides forward within the guide hole 37 disposed in the lower wall 35 of the case 1, and the leading end of the rectangular support plate 32b extended forward from the rectangular block 32a collides with the front end edge 37b of the guide hole 37, thereby preventing the slide switch 25 from moving forward.

At the same time, the guide body 33 fixed to the upper end of the sliding body 32 also moves forward, and the inclined upper face of the upper frame 33b is pressed and retained by the inclination pressing plate 38.

In this state, as shown in FIGS. 12 and 14, the guide pin 30 of the pawl 24a, which is fitted and inserted into the guide groove 34 which is upward inclined toward a rear side from a front side and is disposed in a back face of the guide body 33, is pressed and retained to an inner edge of a crossing curve part between the upper frame 33b and the rear frame 33d of the guide groove 34 by the energizing force of the torsion spring 26.

The pawl 24a axially supported rotatably to the protruded shaft 27 in the inner wall of the case 1 moves upward and rotates around the protruded shaft 27 toward a direction of the arrow in FIG. 14 as mentioned above, and is pressure contacted with the outer periphery of the gear 3.

Next, as shown in FIGS. 18B and 18C, when the optical fiber cord 4 of the optical patch cord is in a state of FIG. 18A in which the optical fiber cord 4 is wound by the winding reel 2 by the energizing force of the power spring 20, within the case 1, the optical connector 5 is pinched by a finger tip and is drawn out of the cord gateway 11 of the case 1. Further, when the optical connector 5 reaches a predetermined length position from the cord gateway 11, the pulling action of the optical connector 5 is stopped. In association with this, the rotation of the winding reel 2 stops and the rotation of the gear 3 integral with the winding reel 2 also simultaneously stops.

During this step, in the process of drawing out the optical fiber cord 4 from the winding reel 2, the pawl 24a pressure contacted with the outer periphery of the gear 3 swings little by little around the protruded shaft 27 when alternately sliding the sliding part 3a and the locking part 3b which are provided in the outer periphery of the gear 3.

At this time, the swing motion of the guide pin 30 of the pawl 24a can be smoothly performed since the vertical width in the rear end of the guide groove 34 to which the guide pin 30 is inserted and attached is formed to be wide so as to function as the clearance part, as shown in FIGS. 14 and 18.

More specifically, the rear frame 33d of the guide body 33 is formed to be longer than the front frame 33c, and the guide pin 30 has room to move down in a direction of an arrow as shown in FIG. 12, thereby causing any trouble for the swinging motion of the pawl 24a.

Further, as shown in FIG. 18C, when the optical connector 5 is slightly drawn out from a predetermined length position, and the optical fiber cord 4 is turned back a little, the energizing force of the power spring 20 finally works, the winding reel 2 and the gear 3 rotate in a clockwise direction, and the pawl 24a pressure contacted with the outer periphery of the gear 3 is locked to the locking part 3b after sliding the sliding part 3a disposed in the outer periphery of the gear 3.

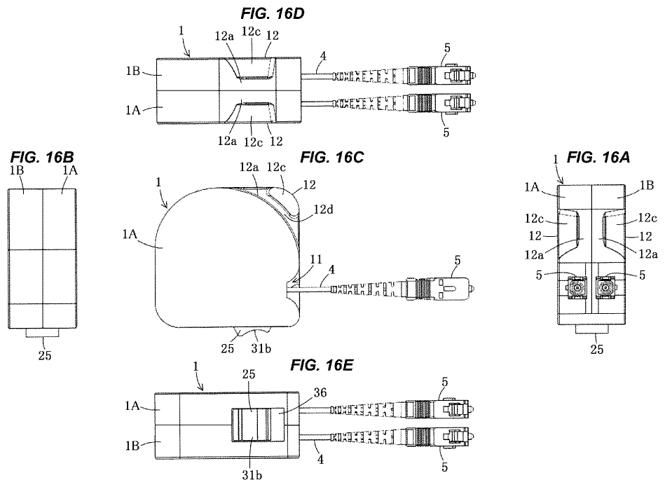

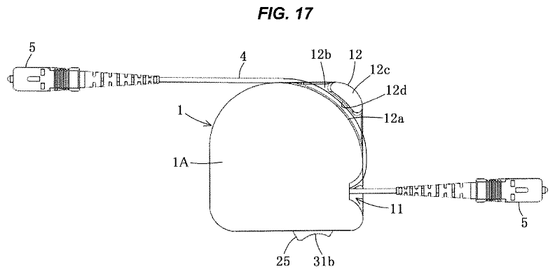

In the used example mentioned above, as shown in FIG. 16, there is shown a state in which the optical connectors 5 in the leading ends of two optical fiber cords 4 are drawn out in the same direction while standing in line to a front side of the gateway 11 of the case 1. However, as shown in FIG. 17, the optical connector 5 in the leading end of one optical fiber cord 4 can be drawn out in the same direction as mentioned above, and the other optical connector 5 can be drawn out in the opposing direction (to a rear side of the case 1) from the gateway 11 of the case 1.

At this time, one is selected from the optical connectors 5 of two optical fiber cords 4 drawn out of the gateway 11 of the case 1. Further, the optical connector 5 of the selected one optical fiber cord 4 is picked by a finger tip, the optical fiber cord 4 is inserted from the opening part 12d outside the cord guide 12 corresponding to the outer optical connector 5, and the optical connector 5 is drawn rearward to the predetermined length position while being wound to the arc-shaped part 12a which is formed in the bottom wall within the cord guide 12. Thereafter motion is the same as mentioned above.

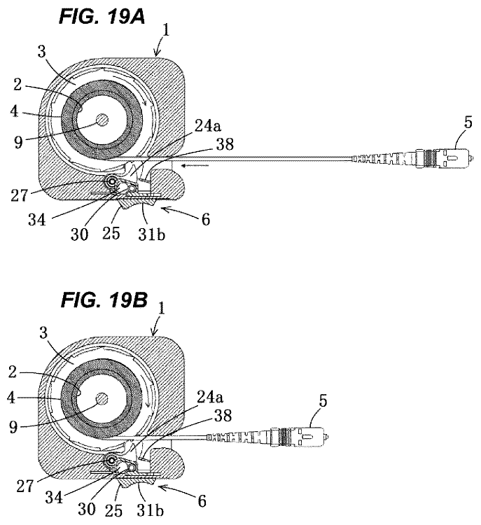

Next, a description will be given of a step of drawing out the optical connector 5 of the optical fiber cord 4 from the cord gateway 11 of the case 1 to the predetermined position, and rewinding the optical fiber cord 4 from the state of FIG. 18C in which the pawl 24a is locked to the locking part 3b disposed in the outer periphery of the gear 3, as mentioned above, on the basis of FIGS. 15 and 19.

As shown in FIG. 15, a hand or finger is applied to the recess face part 31b of the manual operation body 31 in the slide switch 25 fitted to the guide bore 36 in the lower wall 35 of the case 1, and the manual operation body 31 of the slide switch 25 is moved to a rear side of the case 1 (the opposing side to the cord gateway 11).

When the slide switch 25 is moved as mentioned above, the rectangular block 32a fixed to the upper face of the manual operation body 31 slides rearward within the guide hole 37 which is disposed in the lower wall 35 of the case 1, and the rear face of the rectangular block 32a collides with the rear end edge 37a of the guide hole 37, so that the rearward movement is blocked together with the slide switch 25.

At the same time, the guide body 33 fixed to the upper end of the sliding body 32 also moves rearward, and the inclined upper face of the upper frame 33b is cancelled from the pressing of the inclination pressing plate 38.

Under this state, as shown in FIG. 15, the guide pin 30 of the pawl 24a, which is fitted and inserted into the guide groove 34 which is disposed in the back face of the guide body 33 and is downward inclined toward the front side from the rear side, is fixed and retained to an inner edge of the crossing curve part between the upper frame 33b and the front frame 33c in the guide groove 34 against the energizing force of the torsion spring 26.

The pawl 24a axially supported rotatably to the protruded shaft 27 in the inner wall of the case 1 moves down and rotates around the protruded shaft 27 toward the direction of the arrow in FIG. 15 as mentioned above, and is cancelled the pressure contact and the lock with respect to the outer periphery of the pawl 24a. More specifically, as shown in FIG. 19, the pawl 24a and the gear 3 are completely separated.

Next, when releasing the hand or finger picking the optical connector 5 drawn out to a state in FIG. 19A, the energizing force of the power spring 20 is applied and the optical fiber cord 4 is automatically wound up to a state of FIG. 19B by the winding reel 2 within the case 1.

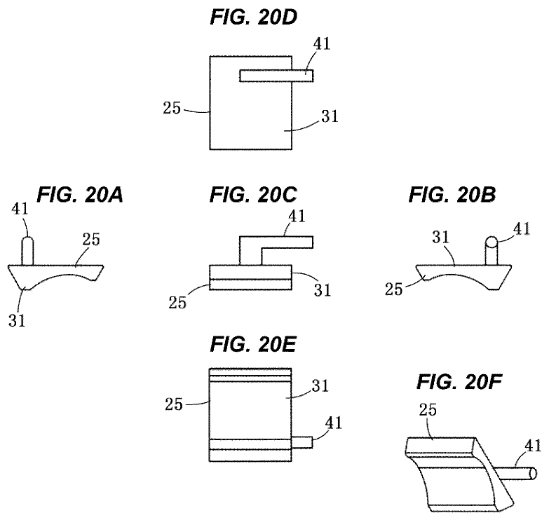

Next, a description will be given of the other example of the rotation control mechanism 6 on the basis of FIGS. 20 to 23.

In the first example mentioned above, the pawl 24a is used as the engaging member 24 constructing the rotation control mechanism 6. However, in the present example, a leaf spring 40 is used.

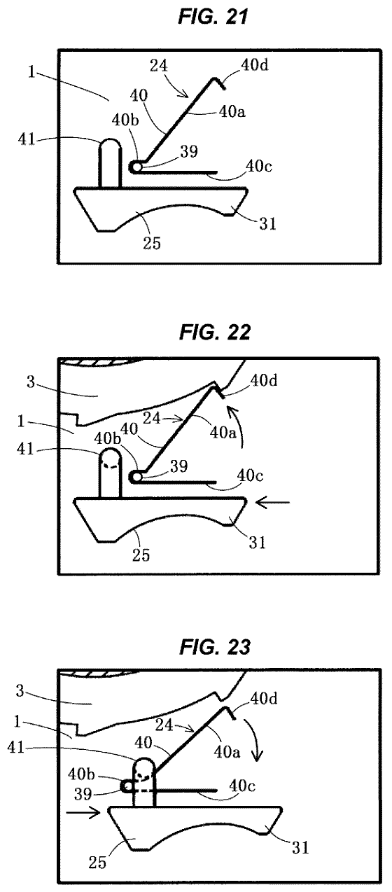

More specifically, as shown in FIGS. 21 to 23, the engaging member 24 is formed by the leaf spring 40 which has an approximately V-shaped form in a side view and is made of metal or plastic. The leaf spring 40 is constructed by an inclined spring plate 40a which is retained by the energizing force of the spring in the direction of always pressure contacting and locking to the gear 3, a holding frame 40b which is fitted and fixed to a support shaft 39 provided in a protruding manner in an inner wall of the case 1 in the spring plate base plate part and has an approximately U-shaped form in a side view, and a horizontal spring plate 40c which is provided in an extending manner in a lower part of the holding frame 40b.

In the drawing, reference symbol 40d denotes a bent plate which is bent inward in a leading end of the inclined spring plate 40a. The bent plate 40d is formed to smoothly engage with the locking part 3b in the outer periphery of the gear 3.

In the meantime, a slide switch 25 used in the leaf spring 40 according to the present example is provided with a manual operation body 31 which is fitted and inserted to a lower wall of the case 1 in a longitudinal direction, and a press bar 41 which passes through the lower wall of the case 1 in an upper part of the manual operation body 31 and is disposed horizontally in an upper rear side thereof, as shown in FIG. 20.

Further, the press bar 41 is formed by extending to a rear side from a rear end of the manual operation body 31 at an approximately equal length to a lateral width of the leaf spring 40. Thus, the leaf spring 40 fitted and fixed to the support shaft 39 provided in a protruding manner in the inner wall of the case 1 is arranged in an adjacent state to the rear end of the slide switch 25, and any trouble does not accordingly occur when the inclined spring plate 40a of the leaf spring 40 moves up and down.

Thus, when the slide switch 25 is moved to a direction of an arrow (leftward direction) and is separated from the leaf spring 40, as shown in FIG. 22, the bent plate 40d in the leading end of the inclined spring plate 40a positioned above the leaf spring 40 pressure contacts and locks to the outer peripheral surface of the gear 3 due to the energizing force. On the contrary, when the manual operation body 31 of the slide switch 25 is slid to a direction of an arrow (rightward direction) of the leaf spring 40, as shown in FIG. 23, the inclined spring plate 40a of the leaf spring 40 presses and moves down by the press bar 41 in association with the positioning of the holding frame 40b of the leaf spring 40 below the press bar 41 of the slide switch 25, and the pressure contact and the lock with respect to the outer peripheral surface of the gear 3 is cancelled.

1. A storage case for an optical patch cord comprising:
a rotation control mechanism which rotatably stores a winding reel and a gear fixed to the winding reel in an inner part of a case, the winding reel being energized and retained by a spring in a state in which an optical fiber cord in an optical patch cord having optical connectors connected to both ends of the optical fiber cord is wound, prevents the winding reel from rotating in a rewinding direction of the optical patch cord by pressure contacting and locking the gear to the lower side within the case, and allows the winding reel to freely rotate by unlocking the gear,
wherein the rotation control mechanism is formed by an engaging member which is retained by an energizing force of a spring in a direction of always pressure contacting and locking a leading end to an outer peripheral face of the gear, and a switch which selectively operates the engaging member to pressure contact and lock to the outer peripheral surface of the gear, or to unlock against the energizing force of the spring the pressure contacting and locking.

2. The storage case for the optical patch cord according to claim 1, wherein the engaging member is formed by a pawl which is axially supported in a base end thereof rotatably to a protruded shaft disposed in an inner wall of the case, is retained in the leading end thereof by the energizing force of the spring in the direction of always pressure contacting and locking to the gear, and is provided with a guide pin in a protruding manner below the leading end.

3. The storage case for the optical patch cord according to claim 1, wherein the switch is provided with a manual operation body which is fitted and inserted to a lower wall of the case so as to be slidable in a longitudinal direction, and a guide body for the pawl which is disposed above an upper part of the manual operation body while passing through the lower wall of the case, the guide body forms in a back face thereof a guide groove which is upward inclined toward a rear side from a front side, and the guide pin for the pawl is slidably fitted and inserted to the guide groove.

4. The storage case for the optical patch cord according to claim 1, wherein the gear is configured to alternately form a sliding part constructed by an inclined face on which the pawl leading end energized and retained by the spring slides over an outer whole periphery, and a locking part constructed by a vertical wall face to which the pawl leading end is locked.

5. The storage case for the optical patch cord according to claim 3, wherein the guide groove of the guide body is formed by an upper frame which is upward inclined toward a rear side from a front side in a rear end edge of a back plate, and a front frame and a rear frame which are continuously disposed vertically below both ends of the upper frame.

6. The storage case for the optical patch cord according to claim 5, wherein a vertical width in a rear end side of the guide groove is formed to be wide so that the guide groove serves as a clearance part for the lock pin when the pawl pressure contacted to the outer periphery of the gear under rotation swings.

7. The storage case for the optical patch cord according to claim 1, wherein the case is formed by coupling opening ends of a pair of two half cases having an approximately rectangular shape in a side view in a lid-fitting manner, and a gateway for the optical fiber cord wound to the winding reel is formed in a front part side of the switch of the rotation control mechanism.

8. The storage case for the optical patch cord according to claim 7, wherein one of the half cases is provided in an inner side thereof with a support shaft which is inserted and attached in a leading end thereof to a holding hole of the other half case, and the winding reel and the gear stored in the inner part of the case are axially supported rotatably to the support shaft.

9. The storage case for the optical patch cord according to claim 8, wherein a circular recess is disposed in a center part of the gear, a through hole of the support shaft is disposed in a center part of the recess, and a power spring energizing and retaining the winding reel in a state in which the optical fiber cord is wound is loaded to an inner part of the recess.

10. The storage case for the optical patch cord according to claim 8, wherein a split groove inserting to wind and fix an inner end of the power spring is formed in the support shaft which axially supports rotatably the winding reel and the gear.

11. The storage case for the optical patch cord according to claim 9, wherein a projection part having a circular arc shape is disposed along an inner periphery of the circular recess in the center part of the gear, and a guide groove inserting to wind and fix an outer end of the power spring and having a circular arc shape is formed between the recess and the projection part.

12. The storage case for the optical patch cord according to claim 7, wherein the winding reel of the optical fiber cord stored in the inner part of the case is formed as double winding reels, the gateway for the optical fiber cord formed in the case is disposed at a lower position facing each reel of the double winding reels, and two optical fiber cords drawn out of the reels are formed in such a manner as to be put in and out in a side-by-side arranged state from the gateway.

13. The storage case for the optical patch cord according to claim 12, wherein the double winding reels are provided with a center flange between the gears arranged in both side faces and an outer flange, and two recess parts for winding the optical fiber cord are formed in an adjacent state between an outer peripheral edge of the gear and the center flange and between the center flange and the outer flange.

14. The storage case for the optical patch cord according to claim 7, wherein a cord guide is disposed in each of corner edge parts just above the gateways in two optical fiber cords, in a pair of two half cases constructing the case.

15. The storage case for the optical patch cord according to claim 14, wherein each of the cord guides disposed in a pair of two half cases is formed in both bottom faces in the arc-shaped part in such a manner as to keep an allowable minimum bend radius of the optical fiber cord.

16. The storage case for the optical patch cord according to claim 12, wherein each of the cord guides disposed in a pair of two half cases is provided with a back part in a protruding manner in a rear side of both the arc-shaped parts, is provided with an upper wall part protruding toward a direction of the arc-shaped part in a protruding manner in a center upper end of the back part, and is formed into an approximately C-shaped form in a front view including an opening part for inserting and removing the optical fiber cord in a front side of the back part.

17. The storage case for the optical patch cord according to claim 1, wherein the engaging member is formed as a leaf spring which has an approximately V-shaped form in a side view and is made of metal or plastic, by an inclined spring plate which is retained by the energizing force of the spring in the direction of always pressure contacting and locking to the gear, a holding frame which is fitted and fixed to the support shaft provided in a protruding manner in the case inner wall in the spring plate base plate part and has an approximately U-shaped form in a side view, and a horizontal spring plate which is provided in an extending manner in a lower part of the holding frame.

18. The storage case for the optical patch cord according to claim 1, wherein the switch is provided with a manual operation body which is fitted and inserted to the lower wall of the case in the longitudinal direction, and a press bar which passes through the lower wall of the case in the upper part of the manual operation body and is horizontally disposed in a rear side of the upper part, and is configured to press and move down an inclined spring plate above the switch with the press bar by sliding the manual operation body of the switch to a direction of the leaf spring, and to unlock the pressure contacting and locking with respect to the outer peripheral face of the gear.

19. The storage case for the optical patch cord according to claim 1, wherein the optical connector connected to both ends of the optical fiber cord is an optical connector of any type of LC type, FC type, SC type, MU type, ST type, KC type, MPO type and MPX type.
